(19) United States
(12) Patent Application Publication
(10) Pub. No.: US 2017/0297238 A1
(43) Pub. Date: Oct. 19, 2017

(54) MOLDING APPARATUS AND METHOD FOR MANUFACTURING AN OPENING DEVICE

(71) Applicant: TETRA LAVAL HOLDINGS & FINANCE S.A., Pully (CH)

(72) Inventors: Jonas BJÖRK, Lund (SE); Anders DANIELSSON, Hörby (SE)

(73) Assignee: TETRA LAVAL HOLDINGS & FINANCE S.A., Pully (CH)

(21) Appl. No.: 15/510,091

(22) PCT Filed: Aug. 20, 2015
(86) PCT No.: PCT/EP2015/069099

§ 371 Date: Mar. 9, 2017

(30) Foreign Application Priority Data
Sep. 11, 2014 (SE) 1451051-5

(51) Int. Cl. B29C 45/14; B65D 17/00; B29L 31/00; B29K 711/12

(52) U.S. Cl. CPC B29C 45/14344; B65D 17/161; B29C 45/14336; B29K 2711/12; B29L 2031/712

(57) ABSTRACT

A molding apparatus for manufacturing an opening device on a package material, comprises a first mold half and a second mold half arranged opposite the first mold half and having a recess. The first mold half comprises a recess and a displaceable cover element covering partly the recess thereby forming a cavity with an opening within the first mold half, wherein the opening is arranged at least partly opposite the recess of the second mold half.

The present invention relates to a molding apparatus. The invention also relates to a method for manufacturing an opening device on a package material blank.

### BACKGROUND OF THE INVENTION

Package containers of the single use disposable type for liquid foods are often produced from a packaging material based on paperboard or carton. Such container is for example be employed for aseptic packaging of liquid foods such as milk, fruit juices etc, marketed and sold for long term ambient storage. The packaging material in such package container is typically a laminate comprising a bulk layer of paper or paperboard, outer, liquid-tight layers of thermoplastics, a gas barrier layer, most commonly an aluminum foil and finally one or more inside layers composed of one or several part layers, comprising heat-sealable adhesive polymers and/or heat-sealable polyolefins.

Package containers of this sort are normally produced on fully automatic packaging machines. In one example, a continuous tube is formed from the web-fed packaging material; the web of packaging material is sterilized in the packaging machine, and the sterilized web of packaging material is maintained in a closed, sterile environment in the subsequent step. The web is folded and sealed longitudinally to form a vertical tube. The tube is filled with the sterilized or sterile- processed food product, and is sealed and subsequently cut along equally spaced cross sections to form pillow packs, which are then folded mechanically to form respective finished, e.g. substantially parallelepiped- shaped, package containers.

Commonly, the package container have an opening device in order to facilitate consumer opening, many different types of opening devices including pull-tabs or molded opening devices, as for example discussed in WO03/095199 25 and WO/2009/000927.

However, the latter type of package is a high-volume (in terms of packages per time unit) and low-cost package (due to the properties of the packaging material), and such opening devices might hamper the production speed and be detrimental for the cost of the package.

For this reason there is a need for an opening device having a high efficiency in regard of the amount of material used and the time needed for production of each opening device.

### SUMMARY OF THE INVENTION

For the purpose of the invention, the term “Package material blank” or “blank” shall include an individual sheet or a blank in a package material web. Such package material web may comprise one or more “package material blanks” arranged after each other in a continuous web, some of those blanks in different processing stages, i.e. on one blank in such web may comprise an opening device, while other blanks on the web might still be unprocessed. The term package material refers to a package material blank or a continuous web of package material.

For the purpose of the invention, the terms container, package and packaging container refer to the same structure. In addition, the terms material, material laminate structure or packaging material refers to the package material blank. The term “cellulosic material” may comprise one or more layers of paper, cardboard or any other cellulosic fiber based material.

For the purpose of this invention, the terms “lateral direction” and transversal direction refer to directions parallel to the surface of packaging material arranged between the mold halves. Consequently both directions span a plane parallel to the surface of the packaging material. More particular, the term “transversal direction” refers to a direction, substantially parallel to a moving direction of the packaging material. The term “vertical direction” refers to a direction perpendicular to said aforementioned plane.

The invention proposes a molding apparatus for manufacturing an opening device on a package material, enabling efficient and flexible manufacturing of such devices. The molding apparatus comprises two mold halves movable arranged opposite to each other. A first mold half is facing a first side of the package material arranged between the halves in operation of the apparatus. The first mold half comprises a recess and a displaceable cover element covering partly the recess thereby forming a cavity having an opening within the first mold half. In this respect, the term cavity refers to hollow in the mold half having an opening, wherein the area of the opening is smaller than a parallel area within the cavity. A recess in contrast thereto is more similar to a groove and generally does not comprise and undercut and the like. The second mold half comprises a recess and is ranged with the recess at least partly facing the opening on the surface of the first mold half.

The cavity in the first mold half allows to mold an opening device on packaging material, which comprises a part, for instance the opening tab displaced to a surface of the package material. The tab can therefore easily be grabbed by a consumer when opening the device. The movable cover element acts as a cover to displace the melt from the package material surface. The recess in the second mold half enables the melt to adhere to the surface of the package material forming a tight connection between the opening device and the package material.

As the mold halves can easily be replaced different shapes for the opening device are possible, allowing flexibility in selection of shapes and functionalities.

The melt can be injected into the mold halves from one side, thereby penetrating due to the injection pressure through the package material filling both, the recess and the cavity, respectively. In an embodiment, the second mold half comprises an injector for injecting a melt material into the recess.

To enable a smooth surface facing the package material, a surface of the cover element may form a planar surface with a surface of the first mold half facing the package material outside the recess in the first mold half. Such planar surface is advantageous to prevent deformation in the package material when the mold halves are closed and pressure is exerted onto the package material.

As mentioned previously, the first mold half comprises a cavity, which may be formed by the movable cover element placed over a recess in the first mold half. In an embodiment, the cover element extends in a lateral direction from a proximal end towards a distal end. The cover element thereby does not cover the recess completely, but leaves an area empty, thereby forming the opening accessing the now formed cavity.

The distal end of the cover is therefore adjacent to the opening, later forming part of the opening device. The distal end may comprise different shapes depending on the needs and requirements for the opening device. For example, the cover element may comprise an arc-like shape, a half-circle, a parabolic shape, linear shape and the like.

In an embodiment, the cover element and the first mold half are relatively movable to each other in a vertical direction, perpendicular to a surface of the first mold half. This allows separating the cover from the mold half, thereby opening the cavity to release the recess. In addition or alternatively, the first mold half may be movable in a direction perpendicular to the first side of the package material, thereby separating the cover element from the cavity to re-form the recess.

In a further embodiment, the second mold half is movable in vertical direction, i.e. in a direction perpendicular to the second side of the package material. Consequently, one or more mold halves can be displaced from the surface of the package material during the operation of the apparatus.

To finally release a manufactured or molded opening, the package material and the cover element may be movable relatively to each other in a direction substantially parallel to the package material. Thereby the manufactured opening can be removed from the mold apparatus. It may be suitable in an embodiment to implement such movement away from a mounting element mounting the cover element movable to the first mold half.

Another aspect of the invention is related to a method for manufacturing an opening device. Such method may comprise the step of providing a package material blank with a multilayer material structure having a layer of cellulosic material, one or more layers of plastic laminate and a penetration area. The package material is arranged between two mold halves.

One of the mold half comprises a cavity with an opening on a first side of the package material blank, wherein an area of the opening facing a first side of the package material blank. The opening is smaller than a projection of an area of the cavity onto the first side.

A second mold half comprises a mold recess on a second side package material blank opposing the first side, wherein the opening partly overlaps the second mold half recess in said penetration area. The second side of the package material is the side later being in contact with liquid food, when a package form the package material is formed and filled. Consequently the first side forms the outer side of a later formed package.

In a subsequent step, a plastic melt is injected into at least one of said cavity and said recess, wherein the melt, due to pressure being built up in said cavity or said recess, penetrates through penetration area and fills also at least said recess and cavity thereby forming an opening device. By doing so, a grip portion of said opening device in said cavity using the injected plastic melt is being formed. After the melt has cooled down, the cavity of said first mold half is opened to release said grip portion and the said grip portion is removed from said cavity by a moving the first mold half and the package material blank relative to each other.

The opening of the cavity may be performed by moving the second mold half and the package material blank relative to each other in a direction perpendicular to the package material blank. In addition or alternatively, the first mold half may be separated into a cover portion and a recess portion by moving the recess portion relative to the package material blank and the cover portion in a direction perpendicular to the package material and the cover portion.

In a further aspect, the cover portion is moved relative to the grip portion in a direction substantially parallel to the first side as to withdraw the cover portion between the grip portion and the first side.

### DESCRIPTION OF THE DRAWING

In the following the present invention will be explained in greater detail using the accompanying drawings, in which

FIG. 1 shows a first cut-view of a molding apparatus with the cavities formed according to an embodiment of the present invention;

FIG. 2 illustrates the first cut-view with the filled cavities according to the embodiment;

FIG. 3 illustrates a second cut-view of the embodiment of FIG. 1 with the cavities filled;

FIG. 4 shows the second cut-view of the embodiment with separated mold-halves according to the invention;

FIG. 5 shows second cut-view of the embodiment with separated mold-halves and displaced packaging material according to the invention;

FIG. 6 illustrates a cut-view of an opening device according to an embodiment of the present invention;

Same or similar features in the following embodiment bear the same reference signs. The various features of the embodiments can be combined in different ways without deviating from the scope of the invention.

### DETAILED DESCRIPTION

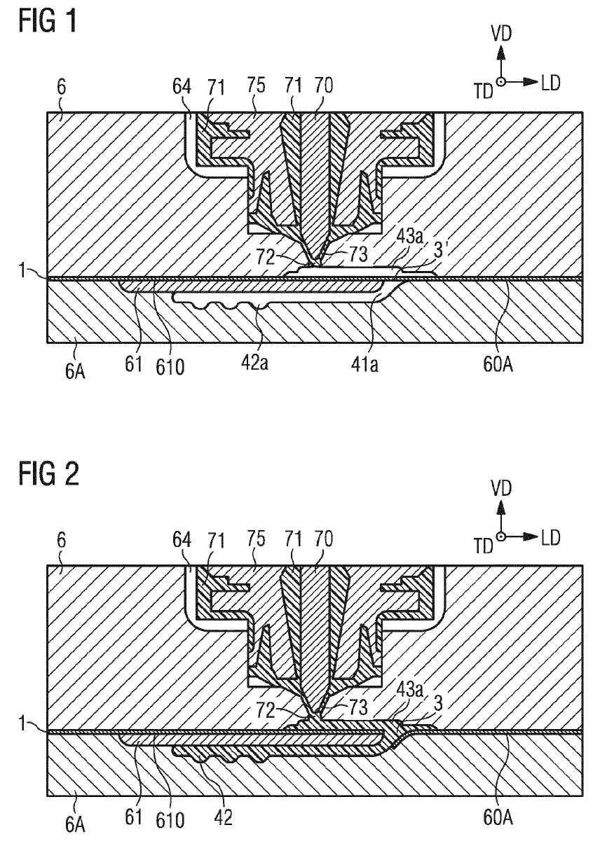

FIG. 1 shows a molding apparatus for manufacturing the opening device according to the present invention.

The molding apparatus comprises a lower or first mold half 6A and an upper or second mold half 6. The second mold half 6, for instance made of stainless steel, aluminum or other suitable material comprises a movable heated cone or similar arrangement 70 to press molten plastic or hot melt through channel 73 and nozzle 72 into a recess 43a. Recess 43 is arranged in the lower side of second mold half 6 facing the package material blank 1. It resembles the structure of the second portion of the opening device.

The first mold 6A half is opposite the second half and the package material blank 1 is arranged between the two halves. The first side of the package material 1 facing first mold half 6A is the outer surface of the package material, i.e. the side with the decor and print thereon. The second side of the package material facing the second mold half 6 corresponds to the inner side of the later formed package and is in food contact later on.

Mold half 6A comprises two major portions, a mold portion 6B with a planar surface 60A facing package material blank 1 and a movable cover 61. Cover 61 is displaceable parallel to vertical direction VD. The cover is arranged in a recess of mold portion 6B to form a cavity 42a for the grip element of the opening device. In other words, cover 61 covers partly the recess of the mold portion to form cavity 42a. Surface 610 of cover 61 is coplanar with surface 60A of mold portion 6B. As a consequence a planar surface is formed, on which the package material is arranged upon.

The cover 61 extends from one end of the recess almost to the other end, leaving a small opening space 41a. The distal end of cover 61 adjacent to said opening 41a is rounded and comprises an arc like shape, which corresponds to the shape for the opening device. Despite the illustrated arc-like shapes, the distal end of cover element 6 can have different shapes depending on the requirements and needs.

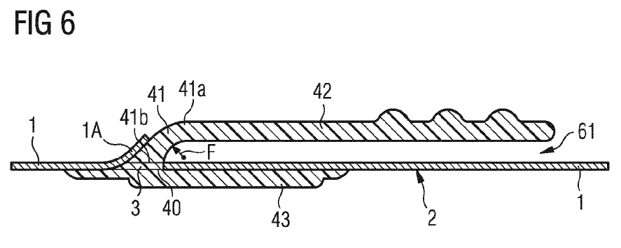

Said opening space 41a resembles the first portion of the opening (see FIG. 6), while cavity 42a is used for molding the grip portion. As illustrated cavity 42a is in its lateral dimension significant bigger than opening area 41a. One can say that a projection of the planar dimension or area of cavity 42a onto the package material is larger than the corresponding area of opening 41a, which corresponds basically to the area 3 of the package material blank. Hence, the space 42a is called cavity, in contrast to space 43a in the second mold half 6 called a recess.

In FIG. 1, the package material blank 1 is moved along the transversal direction TD and arranged between the two mold halves covering the recess 43a of second mold half and opening 41a of the first mold half 6A. Both mold halves and the package material blank 1 are arranged opposite each other in such way that opening 41a faces the recess 43 separated by the penetration area 3 of package material blank 1.

After the mold halves are placed on the package material blank, the molten plastic material 71 is injected into the recess 43a. This is shown in FIG. 2. More particularly cone 70 is slightly retracted and molten plastic is pressed with high pressure through channels 73 and nozzle 72 into recess 43a. Recess 43a is filled with molten plastic forming a portion 43 of the opening device. Due to the high pressure, the plastic penetrates through the package material blank in area 3 and also fills cavity 42a. Part of the package material follows the shape of the recess and adjoins with the molten plastic. The melt in area 42a correspond to the grip portion of the opening device. During this procedure, the package material is not moved at all and both halves are pressed upon the package material.

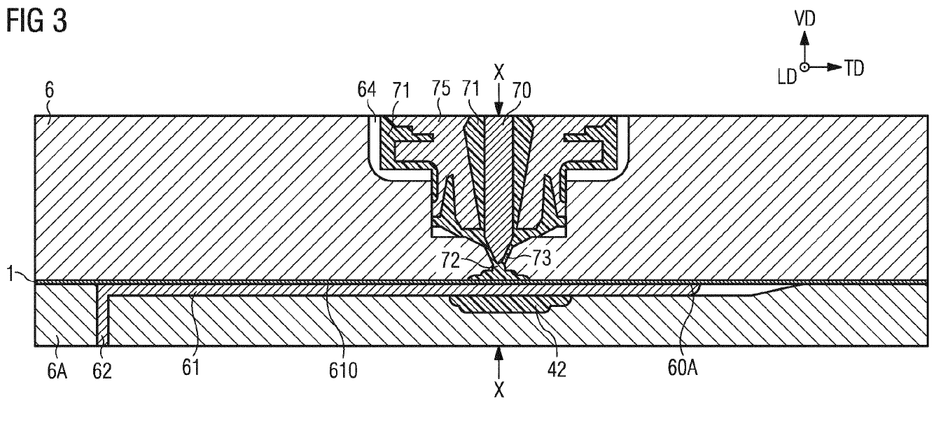

FIG. 3 illustrates the embodiment of the mold apparatus rotated around the axis X-X by 90 degrees. The melt is injected through the nozzle 72 into the recess and has penetrated through the material. The cover 61 extends in transversal direction and is coupled to a mounting element 62. Said mounting element is relatively movable to the mold half portion 6B in vertical direction.

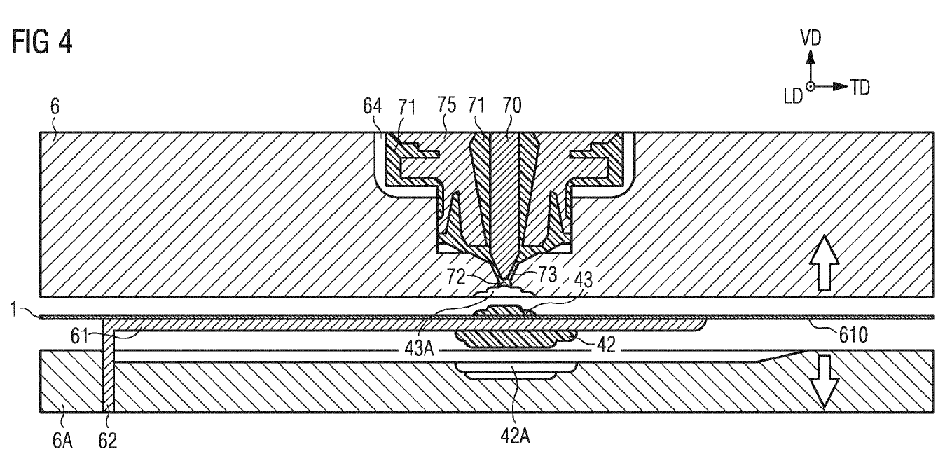

FIG. 4 illustrates another arrangement of the molding apparatus, after the melt operation has been performed and the melt is cooled down. The first mold half 6 is displaced in vertical direction to separate the mold half from the package material 1. The recess 43a is separated from the mold opening device portion 43. The cone 70 closes channels 73, as to prevent molten plastic from flowing through the nozzle 72. The displacement or distance between mold half 6 and package material 1 is larger than a height of portion 43. Likewise, the first mold half 6A is separated into the cover 61 and mold half portion 6B. The cover 61 stays in contact with the surface 610 of the package material 1. The mold half portion 6B is displaced, releasing recess 42A. More particularly, portion 6B is moved downwards along vertical direction VD. Thereby the molded grip portion 42 is separated from recess 42a. Cover 61 provides stability for the package material to prevent undesired bending of material 1.

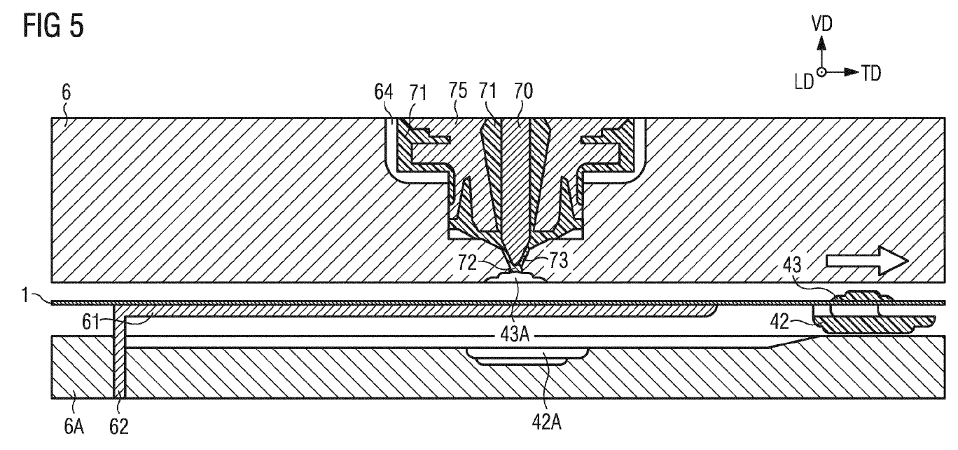

FIG. 5 illustrates the final step of removing the molded opening device. For this purpose, the package material is moved in transversal direction TD, away from the mounting element 62. By doing so the cover 61 is withdrawn from the space between grip portion and package material blank forming the displaced grip portion. As soon as the newly molded opening device has left the molding apparatus and the space between the two mold halves, mold half portion 6B can be moved upwards again to cover the recess 42A with the cover element 61 and likewise second mold half 6 displaced downwards. A new package material blank 1 is fed into the apparatus.

FIG. 6 illustrates the cut-view of an opening device manufactured by an apparatus of the foregoing.

The opening device is molded onto the packaging material in the penetration area 3. Penetration area 3 comprises a smaller thickness than the surrounding area of package material blank 1. For example, the cellulosic layer has been removed and only one or more plastic layers and the aluminum layer remain in penetration area 3. The penetration area 3 is larger than the material bridge 40 of the opening device penetrating area 3. Consequently the package material is arranged in the molding apparatus in such way, that area 3 is facing the opening 41a.

In some other alternatives, the pressure exerted by the mold halves of the molding apparatus is high enough to penetrate through the packaging material directly without having the need of a weakened penetration area 3. In such alternative embodiment, the package material blank 1 is penetrated in the penetration area 3, ripping the material apart and bending a portion 1A of the package material blank upwards. The bent material is attached to the first portion 41 on its surface.

The material bridge 40 adjoins and connects the first portion 41 with the second portion 43. Second portion 43 does not only cover penetration area 3 completely, but also extends onto the surrounding areas on the lower side of the packaging material. It is rigidly attached to the package material facilitating the consumer opening area 2 to prevent the plastic material of the second portion just to be torn of, when a consumer pulls on the grip portion 42.

The first portion 41 is attached with its proximal end 41b to the material bridge 40 and with its distal end 41a to the grip portion 42. More particular, first portion 41 bends from its proximal end towards the consumer are 2 and its distal end. As the opening device is made in one piece, e.g. by injection molding, one can say that first portion 41 merges on the one side into the material bridge 40 and on the other side into the grip portion 42. The grip portion 42 is displaced from the surface of blank 1 by a distance D (not shown). Said distance can be in the range of less than a millimeter to up to some millimeter. For example it can be in the range of 1,5 mm to 3,5 mm and particular 2,5 mm. It depends on the protrusion of the first portion above the surface of package material blank 1.

In this embodiment, first portion comprises a circular shape such that the surface of the distal end 41a is substantial perpendicular to the surface of blank 1. The circular shape can be such that a focal or center point F lies in the space 61 between the grip portion and the surface of the blank 1. Despite the circular shape shown here other shapes, like arcs, parabolic shapes and the like can be used.

FIG. 7 illustrates the various method steps for manufacturing an opening device according to the present invention. In Step S1 the package material is moved between the two mold halves. The package material blank comprises a multilayer material structure having a layer of cellulosic material, one or more layers of plastic laminate and a penetration area. In step S2, the first mold half comprising the cavity with an opening on a first side of the package material blank. Said cavity is formed by moving a cover portion relatively to a recess portion to partly cover a recess in the recess portion. The cover portion is arranged such that it forms a coplanar surface with the surface of the recess portion 6A facing the package material blank. An area of the opening facing the package material blank is smaller than a projection of an area of the cavity onto the blank.

In accordance with step S3, a second mold half with a mold recess is then arranged on the other side of the package material blank, whereby the opening area partly overlaps the recess of the second mold half mold half recess in said penetration area.

The plastic mold is injected in step S4 into the recess or the cavity, for example it is injected into the recess at high pressures, thereby penetrating through the material in the overlapping areas. The molten plastic or injection material fills the cavity and the recess and is at least partly hardened subsequently to form the opening device.

In step S5, the cavity is opened to release the grip portion and the grip portion is removed. The opening can be achieved in reversed order as step S3 and S2, respectively. For instance, the recess portion may be moved downwards away from the package material blank, while the cover is kept facing the package material plank. To remove the grip portion, the package material blank may be moved in a longitudinal direction.

### REFERENCE LIST

1 package material blank
3 penetration area
4 opening device
40 material bridge
41 first portion
41a distal end,
41b proximal end
42 grip portion
42a cavity
43 second portion
43a recess
6 second mold half
6A first mold half
6B first mold half portion
60A surface
61 cover
610 surface
70 cone
71 molten plastic
72 nozzle
73 channel
F focal center
D distance
TD transversal direction
LD longitudinal direction
VD vertical direction

1. A molding apparatus for manufacturing an opening device on a package material, comprising:
a first mold half facing, when in use, a first side of the package material;
a second mold half arranged opposite the first mold half and having a recess, said recess facing, when in use, a second side of the package material; and
wherein the first mold half comprises a recess and a displaceable cover element covering partly the recess thereby forming a cavity with an opening within the first mold half, wherein the opening is arranged at least partly opposite the recess of the second mold half.

2. The molding apparatus of claim 1, wherein one of the mold halves, particularly the second mold half comprises an injector nozzle for injecting a melt material into the recess, wherein, when in use, the melt material, due to pressure being built up in said recess, penetrates through the package material and fills also said cavity for generation of an opening device extending through the package material.

3. The molding apparatus of claim 1, wherein a surface of the cover element forms a planar surface with a surface of the first mold half facing the package material outside the recess in the first mold half.

4. The molding apparatus of claim 1, wherein the cover element extends in a lateral direction from a proximal end towards a distal end adjacent to the opening.

5. The molding apparatus of claim 4, wherein the distal end of the cover element comprises at least one of the following shapes:
an arc-like shape;
a parabolic shape; and
linear shape;

6. The molding apparatus of claim 1, wherein the cover element and the first mold half are relatively movable to each other in a vertical direction, perpendicular to a surface of the first mold half.

7. The molding apparatus of claim 1, wherein, when in use, a portion of the first mold half is movable in vertical direction, perpendicular to the first side of the package material, thereby separating the cover element from the cavity to re-form the recess.

8. The molding apparatus of claim 1, wherein, when in use, the second mold half is movable in vertical direction, perpendicular to the second side of the package material.

9. The molding apparatus of claim 1, wherein the package material and the cover element are relatively movable to each other in transversal direction away from a mounting element coupling the cover element movable to the first mold half.

10. The molding apparatus of claim 1, wherein the cavity of the first mold half comprises additional arc shaped recesses extending in transversal direction.

11. A method for manufacturing an opening device, comprising:
providing a package material blank with a multilayer material structure having a layer of cellulosic material, one or more layers of plastic laminate and a penetration area;
arranging a first mold half comprising a cavity with an opening on a first side of the package material blank, wherein an area of the opening facing the first side is smaller than a projection of an area of the cavity onto the first side;
arranging a second mold half comprising a mold recess on a second side package material blank opposing the first side, wherein the opening partly overlaps the second mold half recess in said penetration area;
injecting a plastic melt into at least one of said cavity and said recess, wherein the melt, due to pressure being built up in said cavity or said recess, penetrates through penetration area and fills also at least said recess and cavity thereby forming an opening device;
generating a grip portion of said opening device in said cavity using the injected plastic melt;
opening the cavity of said first mold half to release said grip portion; and
removing the grip portion from said cavity by relatively moving the first mold half and the package material blank.

12. The method of claim 11, wherein the opening of the cavity comprises
moving the second mold half and the package material blank relative to each other in a direction perpendicular to the package material blank;
separating the first mold half into a cover portion and a recess portion, by moving the recess portion relative to the package material blank and the cover portion in a direction perpendicular to the package material and the cover portion, wherein the cover portion is arranged between the package material blank and the grip portion; and
moving the cover portion relative to the grip portion in a direction substantially parallel to the first side as to withdraw the cover portion between the grip portion and the first side.

13. The method of claim 11, wherein arranging the first mold half comprises:
providing a half mold portion having a recess;
providing a cover portion partly covering the recess as to form a cavity having an opening, wherein a lid portion is relatively movable to the recess portion in a direction perpendicular to a plane substantially parallel to a surface of the cover portion facing the first side; and
arranging the cover portion in the recess to form a planar surface of the first mold half, said planar surface facing the first side.
